(19) United States
(12) Patent Application Publication
(10) Pub. No.: US 2006/0285700 A1
(43) Pub. Date: Dec. 21, 2006

(54) Anti-pop driver circuit

(76) Inventors: Matthew D. Felder, Austin, TX (US); Jeffrey C. Defilippi, Austin, TX (US)

Correspondence Address: GARLICK HARRISON & MARKISON, P.O. BOX 160727, AUSTIN, TX, 78716-0727, US

(21) Appl. No.: 11/155,053

(22) Filed: Jun. 17, 2005

(51) Int. Cl. H04B 15/00

(52) U.S. Cl. 381/94.5

(57) ABSTRACT

An anti-pop driver circuit, which may be incorporated in an audio processing integrated circuit, includes a right channel driver module, a left channel driver module, a center channel driver module, and a control module. The right, left, and center channel driver modules are operably coupled to produce channel outputs in accordance with a channel control signals. The control module is operably coupled to detect power-up of the anti-pop driver circuit, and, when detected, it provides a first state of the center channel control signal to the center channel driver module such that the center channel output is in a high impedance state; provides the right channel control signal to the right channel driver module such the right channel output ramps up at a desired rate; provides the left channel control signal to the left channel driver module such the left channel output ramps up at the desired rate; and, when the right and left channel outputs have reached a desired level, provides a second state of the center channel control signal to the center channel driver module such that the center channel output is a reference potential for the right and left channel outputs.

### BACKGROUND OF THE INVENTION

1. Technical Field of the Invention

This invention relates generally to audio processing and more particularly to headphone and/or speaker drivers.

2. Description of Related Art

Driver circuits are known in the audio processing art to provide sufficient power to drive an audible rendering load (e.g., headphones, speaker(s), line-out connections, etc.). As is also known, there are a variety of driver circuit implementations to provide a headphone driver. For example, FIG. 1 is a schematic block diagram of a known headphone driver implementation. In this driver, a center tap of a headphone jack is coupled to ground and the left and right taps of the headphone jack are capacitor coupled to a left channel driver and a right channel driver, respectively.

For an integrated circuit implementation of the driver of FIG. 1, the left and right channel drivers are on-chip, while the capacitors are off-chip. In such an implementation, the left channel driver drives a signal that includes a left channel signal (V_left_ch) and an DC bias (VAG) and the right channel driver drives a signal that includes a right channel signal (V_right_ch) and a DC bias (VAG). The capacitors remove the DC bias component from the signals such that the headphone jack receives only the left channel signal component (V_left_ch) and the right channel signal component (V_right_ch). While this driver circuit offers the advantages of having only two integrated circuit (IC) pins, it requires large off-chip capacitors (e.g., 100 μF-400 μF). To avoid a “pop” (i.e., a large audible tone) at start up of this driver circuit, the inputs to the left and right channel drivers is ramped up at a slow enough rate to be inaudible (e.g., 50 mSec).

FIG. 2 illustrates another known headphone driver circuit that is capacitorless. As shown, this headphone driver includes a left channel driver, a center channel driver, and a right channel driver. The center channel driver drives a DC bias reference voltage (VAG), which is provided to the center connection of the headphone jack. The left and right channel drivers drive signals that include a signal component and a DC bias component (e.g., VAG+V_left_ch; VAG+V_right_ch). As such, the left connection of the headphone jack, with respect to the center connection, receives the left channel signal component (V_left_ch) and the right connection of the headphone jack, with respect to the center connection, receives the right channel signal component (V_right_ch). While this driver eliminates the need for off-chip capacitors and the ramping of the inputs to the left and right channel drivers, it requires an extra IC pin. In addition, if the headphone jack is grounded, or connected to something other than a headphone (e.g., a speaker), a “pop” may occur. As is known in the art, the driver may have overload protection circuitry to prevent damage due to a short, but such circuitry does not address the “pop” that may result.

Therefore, a need exists for an anti-pop headphone driver that provides the capacitorless headphone driver without the disadvantages.

### BRIEF SUMMARY OF THE INVENTION

The anti-pop headphone driver of the present invention substantially meets these needs and others. In one embodiment, an anti-pop driver circuit, which may be incorporated in an audio processing integrated circuit, includes a right channel driver module, a left channel driver module, a center channel driver module, and a control module. The right channel driver module is operably coupled to produce a right channel output in accordance with a right channel control signal. The left channel driver module is operably coupled to produce a left channel output in accordance with a left channel control signal. The center channel driver module is operably coupled to produce a center channel output in accordance with a center channel control signal. The control module is operably coupled to detect power-up of the anti-pop driver circuit. When the control module detects power-up of the anti-pop driver circuit, the control module provides a first state of the center channel control signal to the center channel driver module such that the center channel output is in a high impedance state; provides the right channel control signal to the right channel driver module such the right channel output ramps up at a desired rate; provides the left channel control signal to the left channel driver module such the left channel output ramps up at the desired rate; and, when the right and left channel outputs have reached a desired level, provides a second state of the center channel control signal to the center channel driver module such that the center channel output is a DC bias reference potential for the right and left channel outputs.

In another embodiment, an anti-pop driver circuit, which may be incorporated in an audio processing integrated circuit, includes a plurality of channel driver modules, a reference driver module, and a control module. The plurality of channel driver modules is operably coupled to produce a plurality of channel outputs in accordance with a channel driver control signal. The reference driver module is operably coupled to produce a channel reference output for the plurality of channel outputs in accordance with a reference driver control signal. The control module is operably coupled to detect power-up of the anti-pop driver circuit. When the control module detects power-up of the anti-pop driver circuit, it provides a first state of the reference driver control signal to the reference driver module such that the channel reference output is in a high impedance state; provides the channel driver control signal to the plurality of channel driver modules such that the plurality of channel outputs ramps up at a desired rate; and, when the plurality of channel outputs reach a desired level, provides a second state of the reference driver control signal to the reference driver module such that the channel reference output provides a reference potential for the plurality of channel outputs.

### BRIEF DESCRIPTION OF THE SEVERAL VIEWS OF THE DRAWINGS

FIGS. 1 and 2 are schematic block diagrams of prior art headphone driver circuits;

FIG. 3 is a schematic block diagram of an audio processing integrated circuit in accordance with the present invention;

FIG. 4 is a schematic block diagram of an embodiment of an anti-pop driver circuit in accordance with the present invention;

FIG. 5 is a logic diagram of a method for controlling an anti-pop driver circuit in accordance with the present invention;

FIG. 6 is a logic diagram of another method for controlling an anti-pop driver circuit in accordance with the present invention;

FIG. 7 is schematic block diagram of another embodiment of an anti-pop driver circuit in accordance with the present invention;

FIGS. 8 and 9 illustrate operational curves of a multi-mode driver in accordance with the present invention; and

FIG. 10 is a schematic block diagram of yet another embodiment of an anti-pop driver circuit in accordance with the present invention.

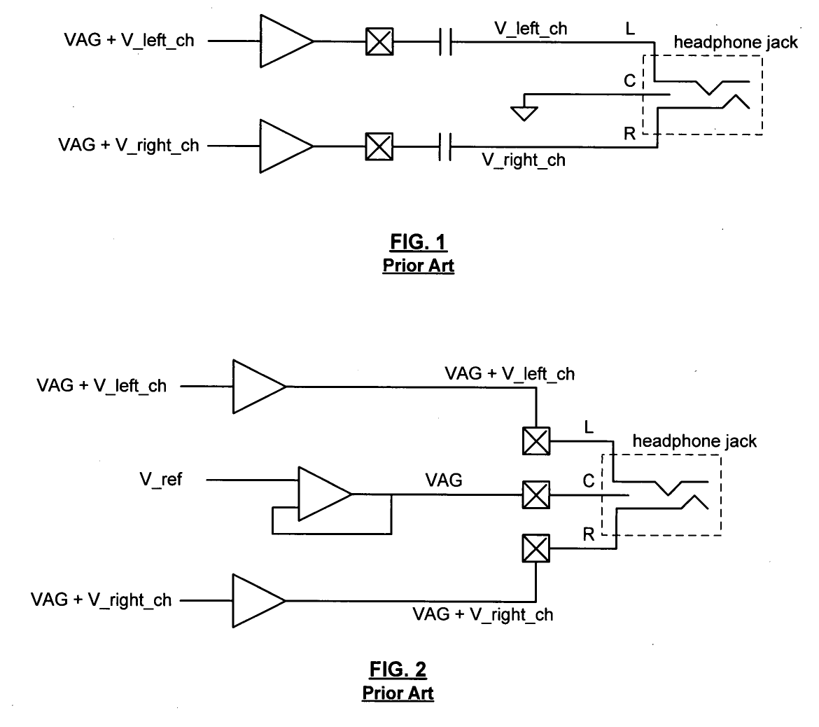

### DETAILED DESCRIPTION OF THE INVENTION

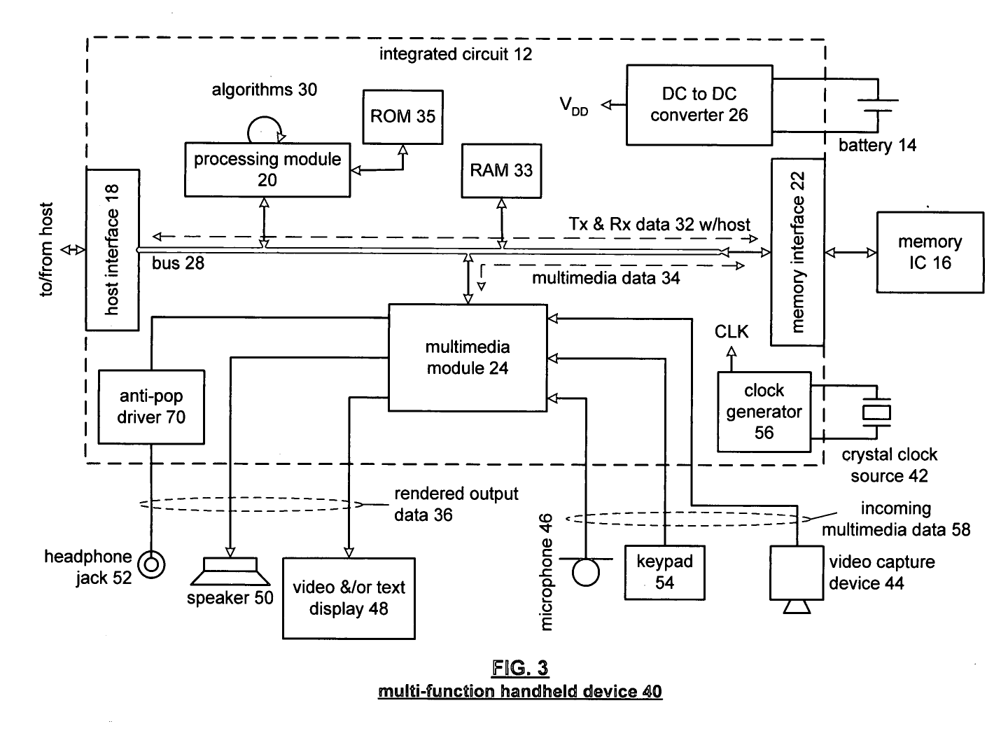

FIG. 3 is a schematic block diagram of a handheld device 40 that includes an integrated circuit 12, a battery 14, memory 16, a crystal clock source 42, one or more multimedia input devices (e.g., one or more video capture device(s) 44, keypad(s) 54, microphone(s) 46, etc.), and one or more multimedia output devices (e.g., one or more video and/or text display(s) 48, speaker(s) 50, headphone jack(s) 52, etc.). The integrated circuit 12 includes a host interface 18, a processing module 20, a memory interface 22, a multimedia module 24, a DC-to-DC converter 26, an anti-pop driver circuit 70, and a clock generator 56, which produces a clock signal (CLK) for use by the other modules. As one of average skill in the art will appreciate, the clock signal CLK may include multiple synchronized clock signals at varying rates for the various operations of the multi-function handheld device.

When the multi-function handheld device 40 is operably coupled to a host device, which may be a personal computer, workstation, server, a laptop computer, a personal digital assistant, and/or any other device that may transceive data with the multi-function handheld device, the processing module 20 performs at least one algorithm 30 where the corresponding operational instructions of the algorithm 30 are stored in memory 16, ROM 35, RAM 33, and/or other memory that may be included and/or coupled to the integrated circuit 12. The processing module 20 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The associated memory may be a single memory device or a plurality of memory devices. Such a memory device may be a read-only memory, random access memory, volatile memory, non-volatile memory, static memory, dynamic memory, flash memory, and/or any device that stores digital information. Note that when the processing module 20 implements one or more of its functions via a state machine, analog circuitry, digital circuitry, and/or logic circuitry, the associated memory storing the corresponding operational instructions is embedded with the circuitry comprising the state machine, analog circuitry, digital circuitry, and/or logic circuitry.

When the multi-function handheld device 40 in the first functional mode, the integrated circuit 12 facilitates the transfer of data between a host device and memory 16, which may be non-volatile memory (e.g., flash memory, disk memory, SDRAM) and/or volatile memory (e.g., DRAM). In one embodiment, the memory IC 16 is a NAND flash memory that stores both data and the operational instructions of at least a portion of one of the algorithms 30.

In this mode, the processing module 20 retrieves a first set of operational instructions (e.g., a file system algorithm, which is known in the art) from the memory 16 to coordinate the transfer of data. For example, data received from the host device (e.g., Rx data) is first received via the host interface module 18. Depending on the type of coupling between the host device and the handheld device 40, the received data will be formatted in a particular manner. For example, if the handheld device 40 is coupled to the host device via a USB cable, the received data will be in accordance with the format proscribed by the USB specification. The host interface module 18 converts the format of the received data (e.g., USB format) into a desired format by removing overhead data that corresponds to the format of the received data and storing the remaining data as data words. The size of the data words generally corresponds directly to, or a multiple of, the bus width of bus 28 and the word line size (i.e., the size of data stored in a line of memory) of memory 16. Under the control of the processing module 20, the data words are provided, via the memory interface 22, to memory 16 for storage. In this mode, the handheld device 40 is functioning as extended memory of the host device (e.g., like a thumb drive).

In furtherance of the first functional mode, the host device may retrieve data (e.g., Tx data) from memory 16 as if the memory were part of the computer. Accordingly, the host device provides a read command to the handheld device, which is received via the host interface 18. The host interface 18 converts the read request into a generic format and provides the request to the processing module 20. The processing module 20 interprets the read request and coordinates the retrieval of the requested data from memory 16 via the memory interface 22. The retrieved data (e.g., Tx data) is provided to the host interface 18, which converts the format of the retrieved data from the generic format of the handheld device into the format of the coupling between the handheld device and the host device. The host interface 18 then provides the formatted data to the host device via the coupling.

The coupling between the host device and the handheld device may be a wireless connection or a wired connection. For instance, a wireless connection may be in accordance with Bluetooth, IEEE 802.11(a), (b) or (g), and/or any other wireless LAN (local area network) protocol, IrDA, etc. The wired connection may be in accordance with one or more Ethernet protocols, Firewire, USB, etc. Depending on the particular type of connection, the host interface module 18 includes a corresponding encoder and decoder. For example, when the handheld device 40 is coupled to the host device via a USB cable, the host interface module 18 includes a USB encoder and a USB decoder.

As one of average skill in the art will appreciate, the data stored in memory 16, which may have 64 Mbytes or of greater storage capacity, may be text files, presentation files, user profile information for access to varies computer services (e.g., Internet access, email, etc.), digital audio files (e.g., MP3 files, WMA—Windows Media Architecture—, MP3 PRO, Ogg Vorbis, AAC—Advanced Audio Coding), digital video files [e.g., still images or motion video such as MPEG (motion picture expert group) files, JPEG (joint photographic expert group) files, etc.], address book information, and/or any other type of information that may be stored in a digital format. As one of average skill in the art will further appreciate, when the handheld device 40 is coupled to the host device, the host device may power the handheld device 40 such that the battery is unused.

When the handheld device 40 is not coupled to the host device, the processing module 20 executes an algorithm 30 to detect the disconnection and to place the handheld device in a second operational mode. In the second operational mode, the processing module 20 retrieves, and subsequently executes, a second set of operational instructions from memory 16 to support the second operational mode. For example, the second operational mode may correspond to MP3 file playback, digital dictaphone recording, MPEG file playback,. JPEG file playback, text messaging display, cellular telephone functionality, and/or AM/FM radio reception. Each of these functions is known in the art, thus no further discussion of the particular implementation of these functions will be provided except to further illustrate the concepts of the present invention.

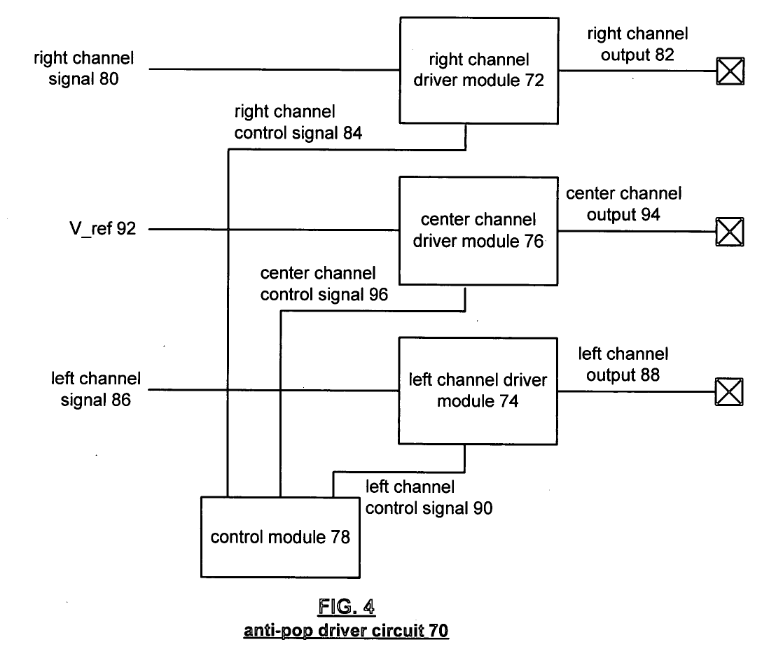

In the second operational mode, under the control of the processing module 20 executing the second set of operational instructions, the multimedia module 24 retrieves multimedia data 34 from memory 16. The multimedia data 34 includes at least one of digitized audio data, digital video data, and text data. Upon retrieval of the multimedia data, the multimedia module 24 converts the data 34 into rendered output data 36. For example, the multimedia module 24 may convert digitized data into audio signals and provides them to a speaker 50 or the anti-pop driver circuit 70. The anti-pop driver circuit 70, which will be described in greater detail with reference to FIGS. 4-10, processes the audio signals to produce analog signals and provides the analog signals to a headphone jack 52. In addition, or in the alternative, the multimedia module 24 may render digital video data and/or digital text data into RGB (red-green-blue), YUV, etc., data for display on an LCD (liquid crystal display) monitor, projection CRT, and/or on a plasma type display (e.g., display 48).

As further applications of the handheld device 40, the handheld device 40 may store digital information received via one of the multimedia input devices 44, 46, and 54 when in the first operational mode. For example, a voice recording received via the microphone 46 may be provided as multimedia input data 58, digitized via the multimedia module 24 and digitally stored in memory 16. Similarly, video recordings may be captured via the video capture device 44 (e.g., a digital camera, a camcorder, VCR output, DVD output, etc.) and processed by the multimedia module 24 for storage as digital video data in memory 16. Further, the key pad 54 (which may be a keyboard, touch screen interface, or other mechanism for inputting text information) provides text data to the multimedia module 24 for storage as digital text data in memory 16. In this extension of the first operational mode, the processing module 20 arbitrates write access to the memory 16 among the various input sources (e.g., the host and the multimedia module).

As even further applications of the handheld device 40, it may record and/or playback multimedia data stored in the memory 16 when in the second operational mode (i.e., not connected to the host). Note that the data provided by the host when the handheld device 40 was in the first operational mode includes the multimedia data. In this embodiment, depending on the type of multimedia data 34, the rendered output data 36 may be provided to one or more of the multimedia output devices. For example, rendered audio data may be provided to the headphone jack 52 an/or to the speaker 50, while rendered video and/or text data may be provided to the display 48.

The handheld device 40 may also record multimedia data 34 while in the second operational mode. For example, the handheld device 40 may store digital information received via one of the multimedia input devices 44, 46, and 54.

As one of average skill in the art, the handheld device 40 may be packaged similarly to a thumb drive, a cellular telephone, pager (e.g., text messaging), a PDA, an MP3 player, a radio, and/or a digital dictaphone and offer the corresponding functions of multiple ones of the handheld devices (e.g., provide a combination of a thumb drive and MP3 player/recorder, a combination of a thumb drive, MP3 player/recorder, and a radio, a combination of a thumb drive, MP3 player/recorder, and a digital dictaphone, combination of a thumb drive, MP3 player/recorder, radio, digital dictaphone, and cellular telephone, etc.).

FIG. 4 is a schematic block diagram of an embodiment of an anti-pop driver circuit 70 that includes a right channel driver module 72, a left channel driver module 74, a center channel driver module 86, and a control module 78. The right channel driver module 72 is operably coupled to produce a right channel output 82 from a right channel signal 80 in accordance with a right channel control signal 84. The left channel driver module 74 is operably coupled to produce a left channel output 88 from a left channel signal 86 in accordance with a left channel control signal 90. The center channel driver module 76 is operably coupled to produce a center channel output 94 from a reference voltage (V_ref) 92 in accordance with a center channel control signal 96. As one of ordinary skill in the art will appreciate, the left and right channel signals 80 and 86 may be part of the rendered output data 36 produced by the multimedia module 24 or another other source that produces stereo channel signals.

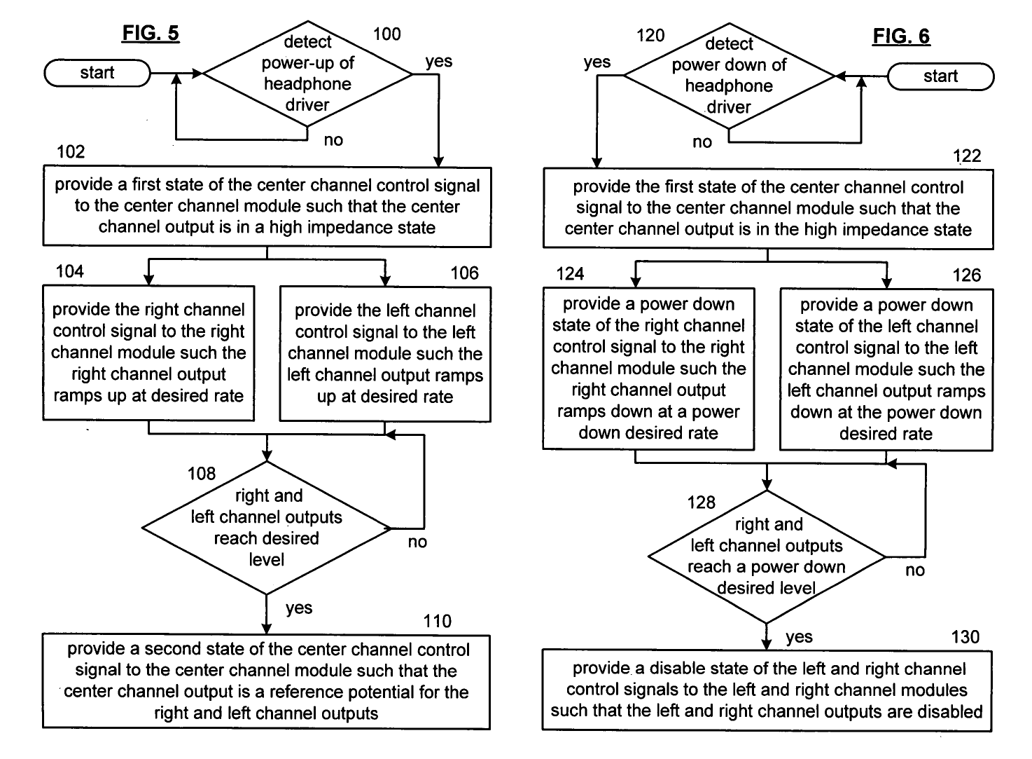

The control module 78 produces the control signals 84, 90, and 96 when the anti-pop driver circuit 70 is powered-up and powered-down. For the power-up sequence, the control module 78 performs the steps of FIG. 5 and, for the power-down sequence, the control module 78 performs the steps of FIG. 6. As one of ordinary skill in the art will appreciate, the control module 78 may be a separate processing module as previously defined herein, may be incorporated in the processing module 20 of the handheld device 40, and/or incorporated in the multimedia module 24 of the handheld device 40.

FIG. 5 is a logic diagram of a method for controlling an anti-pop driver circuit 70 that begins at step 100, where the control module 78 is monitoring the anti-pop driver circuit to detect when it is powered-up. When the power-up of the anti-pop driver circuit is detected, the process proceeds to step 102, where the control module 78 provides a first state of the center channel control signal to the center channel driver module such that the center channel output is in a high impedance state. The process then proceeds to steps 104 and 106. At step 104, the control module 78 provides the right channel control signal to the right channel driver module such the right channel output ramps up at a desired rate. At step 106, the control module 78 provides the left channel control signal to the left channel driver module such the left channel output ramps up at the desired rate. The process then proceeds to step 108 where the control module 78 monitors the left and right channel outputs to determine when they have reached a desired level (e.g., common mode voltage corresponds to VAG). Note that if the left and/or the right outputs are coupled to a device that is providing a short to ground, or are coupled to a device that is not compatible with a headphone jack output (e.g., a monotone speaker), the output(s) will not reach the desired level. Further note that overload protection circuitry may be included to prevent damage to the left, right, and/or center channel driver modules.

When the right and left channel outputs have reached a desired level, the process proceeds to step 110, where the control module 78 provides a second state of the center channel control signal to the center channel driver module such that the center channel output is a reference potential for the right and left channel outputs. With such a method, the driver module 70 is powered up in a controlled manner to avoid a pop if one or more of its outputs is coupled to ground or coupled to a device not compatible with a headphone jack output. For instance, if the center connection of the headphone jack is shorted to ground, the ramping of the left and right channels will avoid a pop in the audible output. Further, in such an instance and as will be discussed in greater detail with reference to FIG. 7, the center channel driver module 76, upon detecting a short, will transition to the high impedance (or Class A, low current) state regardless of the state of the center channel control signal 96.

FIG. 6 is a logic diagram of another method for controlling an anti-pop driver circuit that begins at step 120, where the control module 120 monitors the anti-pop driver for power down. When the control module 78 detects power down of the anti-pop driver circuit the process proceeds to step 122, where the control module 78 provides the first state of the center channel control signal to the center channel driver module such that the center channel output is in the high impedance state. The process then proceeds to steps 124 and 126. At step 124, the control module 78 provides a power down state of the right channel control signal to the right channel driver module such the right channel output ramps down at a power down desired rate. At step 126, the control module 78 provides a power down state of the left channel control signal to the left channel driver module such the left channel output ramps down at the power down desired rate. The process then proceeds to step 128 where the control module 78 monitors the left and right channel outputs to determine when they reach the desired power down level (e.g., zero volts or a voltage corresponding to a logic zero). When the right and left channel outputs have reached a power down desired level, the process proceeds to step 130 where the control module 78 provides a disable state of the left and right channel control signals to the left and right channel driver modules such that the left and right channel outputs are disabled.

FIG. 7 is schematic block diagram of another embodiment of an anti-pop driver circuit 70 that includes the right channel driver module 72, the left channel driver module 74, the center channel driver module 86, and the control module 78. The control module 78 functions as previously discussed with reference to FIGS. 4-6.

In this embodiment, each of the right and left channel driver modules 72 and 74 includes a digital to analog converter (DAC) 140, 144 and a driver 142, 146. The driver may be a unity gain amplifier or some other circuit that has a relatively high input impedance, a relatively low output impedance and substantially maintains the integrity of its input. As shown, the right and left channel control signals 84 and 90 may be provided to the DAC 140, 144 or to the driver 142, 146. When the control signal 84, 90 is provided to the DAC 140, 144, the DAC 140, 144 ramps its output at a predetermined rate (e.g., 50 mSec to achieve the desired level). As alternative, the DAC 140, 144 may ramp its input. As a further alternative, the control module 78 may provide the control signal 84, 90 to a source providing the left and right channel signals 80 and 86 to the channel driver modules 72 and 74 such that the source ramps the input to the driver modules 72 and 74.

When the control signal 84, 90 is provided to the driver 142, 144, the driver 142, 144 ramps its output at the predetermined rate. As one of ordinary skill in the art will appreciate, there are a variety of ways to control a driver to ramp its output.

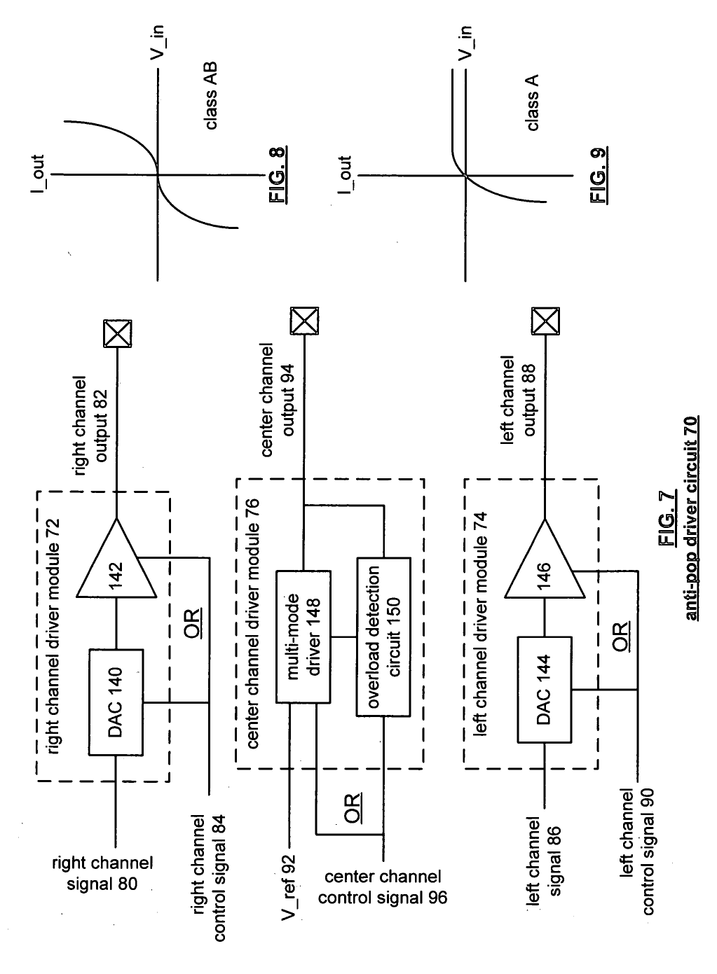

As is also shown in this embodiment, the center channel driver module 76 includes a multi-mode driver 148 and an overload detection circuit 150. The multi-mode driver 148 or the overload detection circuit 150 may receive the center channel control signal 96. The multi-mode driver 148 functions as a class AB amplifier in a first mode and as a class A amplifier in a second mode. The function of a class AB amplifier is depicted in FIG. 8 where output current (I_out) varies according to the input voltage (V_in). The function of a class A amplifier is depicted in FIG. 9 where the output current (I_out) is limited to a set level once the input voltage (V_in) exceeds a positive value. Accordingly, the current limit of the class A amplifier may be set at a level that provides an effect high impedance state for the output of the center channel driver module 78.

The multi-mode driver 148 may be placed in the second mode (i.e., the Class A amplifier high impedance mode) either due to an overload condition sensed by the overload detection circuit 150 or in response to first state of the center channel control signal 96. The multi-mode driver 148 may be placed in the first mode (i.e., the Class AB amplifier mode) when an overload condition does not exist and when the center channel control signal 96 is in the second state.

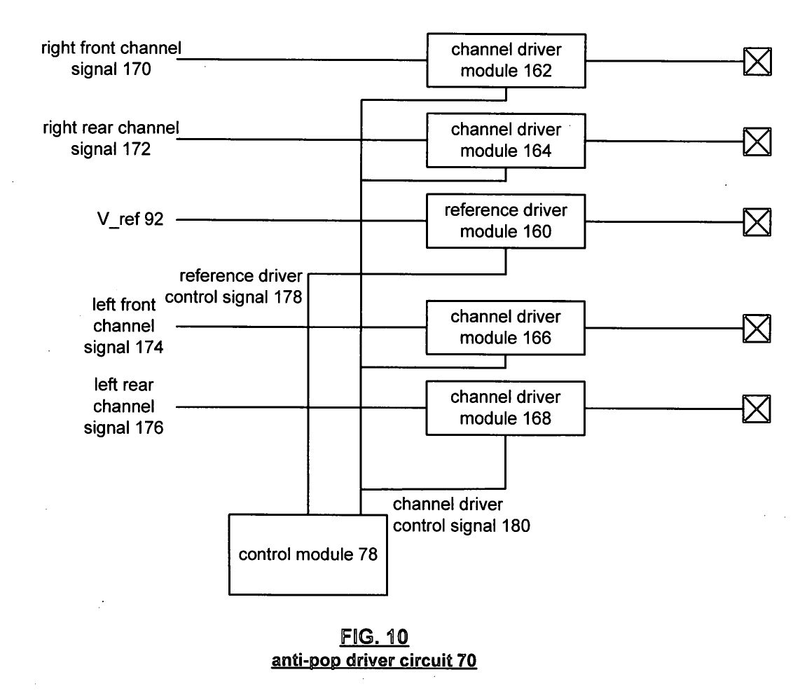

FIG. 10 is a schematic block diagram of yet another embodiment of an anti-pop driver circuit 70 that includes a plurality of channel driver modules 162-168, a reference driver module 160, and the control module 78. The plurality of channel driver modules 162-168 is operably coupled to produce a plurality of channel outputs from a plurality of channel signals 170-176, which may correspond to surround sound signals, in accordance with a channel driver control signal 180. The reference driver module 160 is operably coupled to produce a channel reference output for the plurality of channel outputs from a reference voltage 92 in accordance with a reference driver control signal 178.

The control module 78 is operably coupled to detect power-up of the anti-pop driver circuit. When the control module 78 detects power-up of the anti-pop driver circuit, it provides a first state of the reference driver control signal to the reference driver module such that the channel reference output is in a high impedance state and provides the channel driver control signal to the plurality of channel driver modules such that the plurality of channel outputs ramps up at a desired rate. When the plurality of channel outputs reaches a desired level, the control module 78 provides a second state of the reference driver control signal to the reference driver module such that the channel reference output provides a reference potential for the plurality of channel outputs.

The control module 78 is also operably coupled to detect power down of the anti-pop driver circuit. When the control module 78 detects power down of the anti-pop driver circuit, it provides the first state of the reference driver control signal to the reference driver module such that the channel reference output is in the high impedance state. The control module 78 then provides a power down state of the channel driver control signal to the plurality of channel driver modules such the plurality of channel outputs ramps down at a power down desired rate. When the plurality of channel outputs have reached a power down desired level, the control module 78 provides a disable state of the channel driver control signal to the plurality of channel modules such that the plurality of channel outputs are disabled.

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled”. As one of ordinary skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The preceding discussion has presented an anti-pop driver circuit. As one of ordinary skill in the art will appreciate, other embodiments may be derived from the teachings of the present invention without deviating from the scope of the claims.

What is claimed is:

1. An anti-pop driver circuit comprises:
a right channel driver module operably coupled to produce a right channel output in accordance with a right channel control signal;
a left channel driver module operably coupled to produce a left channel output in accordance with a left channel control signal;
a center channel driver module operably coupled to produce a center channel output in accordance with a center channel control signal; and
a control module operably coupled to:
detect power-up of the anti-pop driver circuit;
when the power-up of the anti-pop driver circuit is detected:
provide a first state of the center channel control signal to the center channel driver module such that the center channel output is in a high impedance state;
provide the right channel control signal to the right channel driver module such the right channel output ramps up at a desired rate;
provide the left channel control signal to the left channel driver module such the left channel output ramps up at the desired rate; and
when the right and left channel outputs have reached a desired level, provide a second state of the center channel control signal to the center channel driver module such that the center channel output is a DC bias potential for the right and left channel outputs.

2. The anti-pop driver circuit of claim 1, wherein the control module further functions to:
detect power down of the anti-pop driver circuit;
when the power down of the anti-pop driver circuit is detected:
provide the first state of the center channel control signal to the center channel driver module such that the center channel output is in the high impedance state;
provide a power down state of the right channel control signal to the right channel driver module such the right channel output ramps down at a power down desired rate;
provide a power down state of the left channel control signal to the left channel driver module such the left channel output ramps down at the power down desired rate; and
when the right and left channel outputs have reached a power down desired level, provide a disable state of the left and right channel control signals to the left and right channel driver modules such that the left and right channel outputs are disabled.

3. The anti-pop driver circuit of claim 1, wherein the center channel driver module comprises:
a multi-mode driver operable as a class AB amplifier in a first mode and operable as a class A amplifier in a second mode when the center channel control signal is in the second state; and
overload detection module operably coupled to detect an overloading of the multi-mode driver, wherein, when the overloading of the multi-mode driver is detected, the overload detection module places the multi-mode driver in the second mode and, when the overloading of the multi-mode driver is not detected, the overload detection module places the multi-mode driver in the first mode.

4. The anti-pop driver circuit of claim 1, wherein the right channel driver module comprises:
a digital to analog converter operably coupled to receive a digital representation of a right channel signal into an analog representation of the right channel signal; and
a driver operably coupled to drive the analog representation of the right channel signal as the right channel output, wherein the right channel control signal controls at least one of ramping up the digital representation of the right channel signal and ramping up of the driver.

5. The anti-pop driver circuit of claim 1, wherein the left channel driver module comprises:
a digital to analog converter operably coupled to receive a digital representation of a left channel signal into an analog representation of the left channel signal; and
a driver operably coupled to drive the analog representation of the left channel signal as the left channel output, wherein the left channel control signal controls at least one of ramping up the digital representation of the left channel signal and ramping up of the driver.

6. An audio processing integrated circuit comprises:
processing module;
memory operably coupled to the processing module, wherein the memory at least temporarily stores operational instructions that cause the processing module to produce digital audio signals; and
an anti-pop driver circuit including:
a right channel driver module operably coupled to produce a right channel output in accordance with a right channel control signal;
a left channel driver module operably coupled to produce a left channel output in accordance with a left channel control signal; and
a center channel driver module operably coupled to produce a center channel output in accordance with a center channel control signal, wherein the memory further at least temporarily stores operational instructions that cause the processing module to:
detect power-up of the anti-pop driver circuit;
when the power-up of the anti-pop driver circuit is detected:
provide a first state of the center channel control signal to the center channel driver module such that the center channel output is in a high impedance state;
provide the right channel control signal to the right channel driver module such the right channel output ramps up at a desired rate;
provide the left channel control signal to the left channel driver module such the left channel output ramps up at the desired rate; and
when the right and left channel outputs have reached a desired level, provide a second state of the center channel control signal to the center channel driver module such that the center channel output is a reference potential for the right and left channel outputs.

7. The audio processing integrated circuit of claim 6, wherein the memory further at least temporarily stores operational instructions that cause the processing module to:
detect power down of the anti-pop driver circuit;
when the power down of the anti-pop driver circuit is detected:
provide the first state of the center channel control signal to the center channel driver module such that the center channel output is in the high impedance state;
provide a power down state of the right channel control signal to the right channel driver module such the right channel output ramps down at a power down desired rate;
provide a power down state of the left channel control signal to the left channel driver module such the left channel output ramps down at the power down desired rate; and
when the right and left channel outputs have reached a power down desired level, provide a disable state of the left and right channel control signals to the left and right channel driver modules such that the left and right channel outputs are disabled.

8. The audio processing integrated circuit of claim 6, wherein the center channel driver module comprises:
a multi-mode driver operable as a class AB amplifier in a first mode and operable as a class A amplifier in a second mode when the center channel control signal is in the second state; and
overload detection module operably coupled to detect an overloading of the multi-mode driver, wherein, when the overloading of the multi-mode driver is detected, the overload detection module places the multi-mode driver in the second mode and, when the overloading of the multi-mode driver is not detected, the overload detection module places the multi-mode driver in the first mode

9. The audio processing integrated circuit of claim 6, wherein the right channel driver module comprises:
a digital to analog converter operably coupled to receive a digital representation of a right channel signal into an analog representation of the right channel signal; and
a driver operably coupled to drive the analog representation of the right channel signal as the right channel output, wherein the right channel control signal controls at least one of ramping up the digital representation of the right channel signal and ramping up of the driver.

10. The audio processing integrated circuit of claim 6, wherein the left channel driver module comprises:
a digital to analog converter operably coupled to receive a digital representation of a left channel signal into an analog representation of the left channel signal; and
a driver operably coupled to drive the analog representation of the left channel signal as the left channel output, wherein the left channel control signal controls at least one of ramping up the digital representation of the left channel signal and ramping up of the driver.

11. An anti-pop driver circuit comprises:
a plurality of channel driver modules operably coupled to produce a plurality of channel outputs in accordance with a channel driver control signal;
a reference driver module operably coupled to produce a channel reference output for the plurality of channel outputs in accordance with a reference driver control signal; and
a control module operably coupled to:
detect power-up of the anti-pop driver circuit;
when the power-up of the anti-pop driver circuit is detected:
provide a first state of the reference driver control signal to the reference driver module such that the channel reference output is in a high impedance state;
provide the channel driver control signal to the plurality of channel driver modules such that the plurality of channel outputs ramps up at a desired rate; and
when the plurality of channel outputs reach a desired level, provide a second state of the reference driver control signal to the reference driver module such that the channel reference output provides a reference potential for the plurality of channel outputs.

12. The anti-pop driver circuit of claim 11, wherein the control module further functions to:
detect power down of the anti-pop driver circuit;
when the power down of the anti-pop driver circuit is detected:
provide the first state of the reference driver control signal to the reference driver module such that the channel reference output is in the high impedance state;
provide a power down state of the channel driver control signal to the plurality of channel driver modules such the plurality of channel outputs ramps down at a power down desired rate; and
when the plurality of channel outputs have reached a power down desired level, provide a disable state of the channel driver control signal to the plurality of channel modules such that the plurality of channel outputs are disabled.

13. The anti-pop driver circuit of claim 11, wherein the plurality of channel driver modules comprises:
a right channel driver module operably coupled to produce a right channel output of the plurality of channel outputs based on a right channel signal; and
a left channel driver module operably coupled to produce a left channel output of the plurality of channel outputs based on a left channel signal.

14. The anti-pop driver circuit of claim 11, wherein the plurality of channel driver modules comprises:
a right front channel driver module operably coupled to produce a right front channel output of the plurality of channel outputs based on a right front channel signal;
a left front channel driver module operably coupled to produce a left front channel output of the plurality of channel outputs based on a left front channel signal;
a right rear channel driver module operably coupled to produce a right rear channel output of the plurality of channel outputs based on a right rear channel signal; and
a left rear channel driver module operably coupled to produce a left rear channel output of the plurality of channel outputs based on a left rear channel signal.
